(19) United States
(12) Patent Application Publication
(10) Pub. No.: US 2018/0174218 A1
(43) Pub. Date: Jun. 21, 2018

(54) RECOMMENDATION OPTMIZATION WITH A DYNAMIC MIXTURE OF FREQUENT AND OCCASIONAL RECOMMENDATIONS

(71) Applicant: SAP SE, Walldorf (DE)

(72) Inventors: Wenjun Zhou, Shanghai (CN); Wen-Syan Li, Shanghai (CN)

(21) Appl. No.: 15/383,636

(22) Filed: Dec. 19, 2016

(51) Int. Cl. G06Q 30/06; G06F 17/30; G06Q 30/02

(52) U.S. Cl. CPC G06Q 30/0631; G06Q 30/0201; G06F 17/30424

(57) ABSTRACT

The present description provides data analysis to provide highly individualized recommendations for users. The recommendations received by a user will include a combination of frequent recommendations and occasional recommendations. The frequent recommendations refer to recommendations made for the same product or type of product repetitively across multiple sets of recommendations, while the occasional recommendations recommend a given product or type of product only rarely across the multiple sets of recommendations. The described techniques and systems automatically determine, through data analysis, which products should be considered frequent and which should be occasional, as well as which products should not be recommended at all (blacklisted). Moreover, when generating a given recommendation set, the described techniques and systems automatically determine an optimal or near-optimal ratio of frequent/occasional recommendations.

### TECHNICAL FIELD

This description relates to data analysis for recommendation systems.

### BACKGROUND

High volumes of data are captured, stored, and available for use in various types of decision-making. However, it is often difficult or impossible for human users of such data to interpret and apply the data, and to engineer computers to operate based on the data and in a manner that optimizes use of the available data.

Computers are often used in various types of recommendation systems. In some contexts, however, it is still difficult or impossible to make large-scale, accurate, useful, and/or timely recommendations.

For example, peoples' preferences are a matter of subjective taste and inclinations, and are therefore highly individualized and difficult to predict. These difficulties are often compounded when generating recommendations for a number of individuals, even when the set(s) of goods or services being recommended are relatively fixed.

For example, some products and services are often used only once, or very rarely within a period of time. For example, a user who purchases a particular book may be unlikely to purchase that same book again any time soon. On the other hand, a user who visits a restaurant may wish to visit the restaurant again in the near future. In still other cases, one user might wish to watch a particular movie only once, while another user might wish to view the same movie multiple times.

For these and other reasons, users may receive recommendations that are not particularly useful to them, and may choose to ignore such recommendations, or may be caused to ignore all of the recommendations. As a result, providers of the recommendations may lose opportunities for sales and improved customer relationships.

### SUMMARY

The present description provides data analysis to provide highly individualized recommendations for users. The recommendations received by a user will include a combination of frequent recommendations and occasional recommendations. The frequent recommendations refer to recommendations made for the same product or type of product repetitively across multiple sets of recommendations, while the occasional recommendations recommend a given product or type of product only rarely across the multiple sets of recommendations. The described techniques and systems automatically determine, through data analysis, which products should be considered frequent and which should be occasional, as well as which products should not be recommended at all (blacklisted). Moreover, when generating a given recommendation set, the described techniques and systems automatically determine an optimal or near-optimal ratio of frequent/occasional recommendations. Accordingly, as multiple recommendations sets are generated over time, the ratio of frequent/occasional recommendations may dynamically change for each recommendation set and for each individual, and products may be dynamically allocated and re-allocated as being frequent, occasional, or blacklisted. Further, a number of uses of, or visits to, each recommended product is tracked over time as recommendations are generated, and used to facilitate accurate and useful selections of the frequent/occasional ratio and the classification of each product as frequent/occasional/blacklisted.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a recommendation system with a dynamic mixture of frequent and occasional recommendations.

FIG. 2 is a flowchart illustrating example implementations of the system of FIG. 1.

FIG. 3A is a table illustrating an example of a customer database of FIG. 1.

FIG. 3B is a table illustrating an example of a products database of FIG. 1.

FIG. 3C is a table illustrating an example of a use history database of FIG. 1.

FIG. 3D is a table illustrating an example of a recommendations history database of FIG. 1.

FIG. 4 is a flowchart illustrating more detailed example operations of the system of FIG. 1.

### DETAILED DESCRIPTION

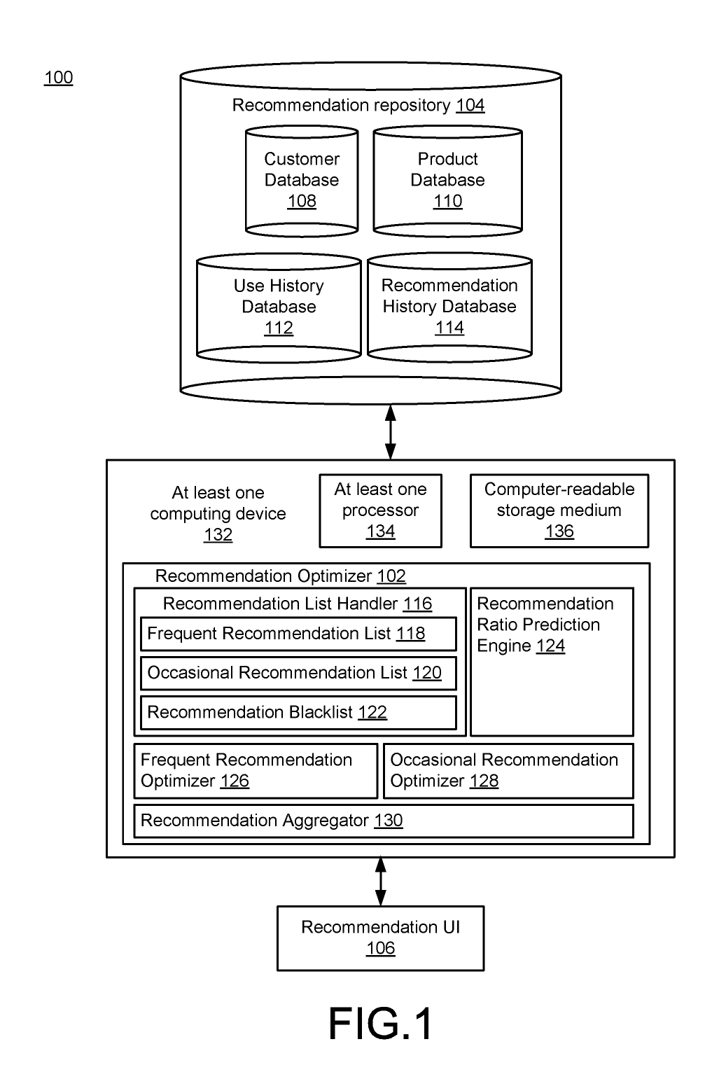

FIG. 1 is a block diagram of a recommendation system 100 with a dynamic mixture of frequent and occasional recommendations. As shown in FIG. 1, a recommendation optimizer 102 may be configured to perform various types of data analysis with respect to data stored using a recommendation repository 104, to thereby provide recommendations by way of a recommendation user interface (UI) 106. As referenced above and described in detail below, the resulting, provided recommendation sets may be provided over a period of time to each individual customer or other user of a plurality of customers/users, while dynamically adjusting, for each set of recommendations, a ratio of frequent/occasional recommendations contained therein. In this way, over time, each customer or other user is more likely to receive recommendations that are useful, and providers of the recommendation sets are more likely to experience increased profit and satisfaction levels of customers.

As also referenced above, for some recommendations and/or users, it is appropriate or desirable to recommend the same product or type of product multiple times. In other scenarios, a user receiving the same recommendation multiple times might find such recommendations to be redundant or useless. Consequently, for example, if a recommendation system provides only frequently-used products or services, and disregards other recommendation candidates, users may find such recommendations, over time, to also become redundant or useless. For example, a user visiting a certain restaurant or type of restaurant may desire to receive frequent recommendations accordingly for some period of time, but may eventually grow tired of such recommendations, and desire to receive entirely different recommendations. On the other hand, if the user consistently receives a wide variation of recommendations that are used only occasionally, then the user may feel that he or she is receiving a large number or proportion of recommendations that are not useful.

As described below, the recommendation optimizer 102 is configured to differentiate between frequent and occasional recommendations, to find a proper proportion of each to be included within a recommendation set, and, when necessary, to reclassify a particular recommendation or type of recommendation from being considered to be a frequent recommendation to be considered an occasional recommendation, or vice versa.

Thus, the recommendation optimizer 102 provides a mixture of frequent and occasional recommendations, and allows recommendations initially classified as being occasional to serve as test candidates to explore unknown or changing taste or interest of the receiving user, which, once discovered, may grow over time to be considered a candidate for frequent recommendations going forward. Conversely, a recommendation initially classified as frequent, but used less frequently or more sporadically over time, may be reclassified as an occasional recommendation, or not included at all.

In some cases, as a result, it may occur that various recommended products may be reclassified from frequent to occasional, or occasional to frequent, as just described, without changing an overall ratio of frequent/occasional recommendations within a given recommendation set. However, as also referenced above, the recommendation optimizer 102 enables dynamic adjustment of the frequent/occasional recommendation ratio, as different recommendations sets are produced for the same customer over a period of time.

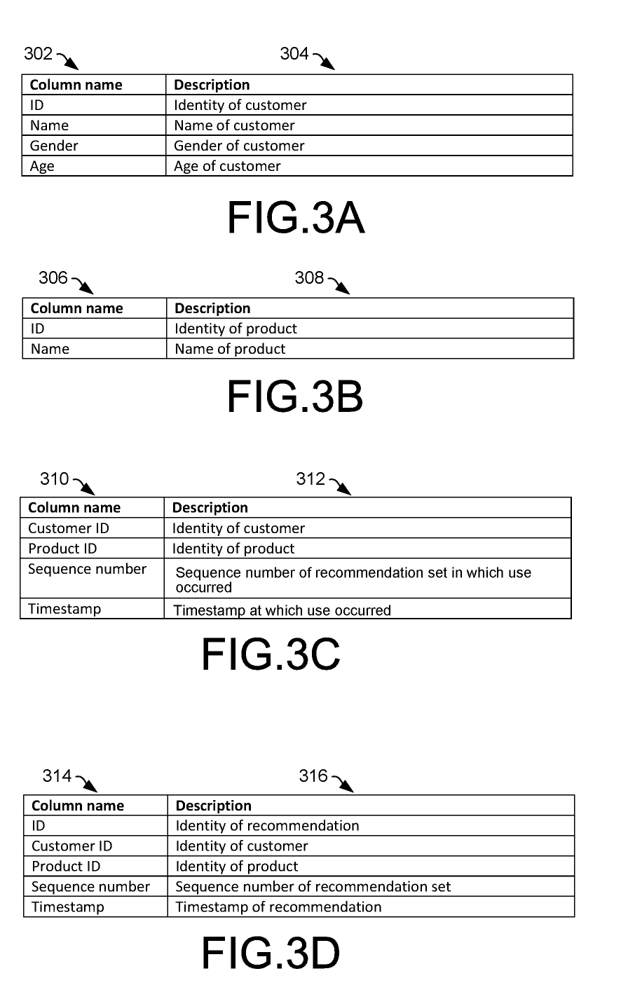

In the example of FIG. 1, as already referenced, the recommendation optimizer 102 is configured to access the recommendation repository 104 to perform the above and other types of data analysis. In the example of FIG. 1, the recommendation repository 104 is illustrated as including a customer database 108, a product database 110, a use history database 112, and a recommendation history database 114, each of which is described in more detail by way of respective example database tables illustrated in FIG. 3A, FIG. 3B, FIG. 3C, and FIG. 3D. Of course, although the recommendation repository 104 is illustrated as a single repository contained the four databases 108-114, it will be appreciated that the various types of data needed may be merged into a smaller number of databases, split into a larger number of databases, and otherwise may be designed, stored, and accessed in any appropriate fashion.

The customer database 108 should generally be understood to include a plurality of customer data records corresponding to individual customers. In this context, it will be appreciated that the term customer should include any user who might potentially receive recommendation sets from the recommendation optimizer 102. For example, such a user may include a potential consumer of a given product or service, who has not yet purchased the product or service, as well as individuals with known purchase histories.

The product database 110 should be understood to include a set of products that may potentially be purchased or otherwise used by individual customers of the customer database 108. For example, in some implementations, some subsets of products of the product database 110 may be designated as including potential recommendations for individual customers or groups of customers of the customer database 108. In other implementations, it may be assumed that any and all products within the product database 110 might be included in potential recommendations for any individual customer of the customer database 108.

A use history 112 provides, where available, individual use histories for individual customers and corresponding products of the product database 110. In this context, it will be appreciated that products of the product database 110 may include product data records referring to virtually any type of product that might be purchased, consumed, or otherwise utilized by individual customers of the customer database 108. For example, such products may include individual retail items for sale, or may include locations (e.g., stores, restaurants, or movie theaters) that may be visited by customers. In other examples, products may include personal services provided (e.g., cleaning or repair services), or services provided over a computer network (e.g., software as a service).

Consequently, the term use in this context should be understood to correspond to the type of product in question, such as a purchase of a book, a visit to a restaurant, or an engagement of a service. Accordingly, the use history database 112 will be understood to be populated over time in a manner that is appropriate for, and corresponds to, the type of products in question. For example, products purchased may be tracked by an ecommerce website providing such products for sale. Restaurants and other locations may be tracked using voluntary permission of a user of the recommendation system 100, or may be obtained using various consumer loyalty programs, consumer surveys, or other appropriate techniques.

For purposes of operation of the recommendation optimizer 102, it is assumed that the use history database 112 includes data characterizing numbers and times of uses of each product of the product database 110 by each customer of the customer database 108. Consequently, for example, and as described in detail below, the use history database 112 provides a basis for calculating a number of times that a particular consumer has used a particular product, as well as how recently each user used a particular product. In various implementations, use histories may be tracked for individual customers with respect to products that have previously been recommended in early-provided recommendation sets, as well as with respect to products that have not yet been recommended.

The recommendation history database 114 may be utilized to store, for example, some or all recommendation sets that have previously been provided to individual customers, including individual products included in each recommendation set, a sequence number of each recommendation set within the overall sequence of recommendation sets provided, and corresponding time stamps for each recommendation set provided. The recommendation optimizer 102 is illustrated as including a recommendation list handler 116, that is configured, for a particular customer and for a particular (e.g., current) recommendation set, to classify each relevant product within the product database 110 as being a potential frequent recommendation, to be included within a frequent recommendation list 118, or a potential occasional recommendation, to be included within an occasional recommendation list 120. In this regard, it will be appreciated that, by themselves, the terms “frequent” and “occasional” may be considered to be relative terms, or terms of degree. Indeed, it is the nature of the problem solved that the recommendation optimizer 102 considers and accounts for the relative and subjective extent to which individuals prefer to receive different types of recommendations.

Nonetheless, for purposes of clarity, as described herein, frequent recommendation product candidates included within the frequent recommendation list 118 will be understood to be those products selected, at least primarily, based on a number of uses of a particular, corresponding product by the customer in question, within a defined or assumed period of time. Meanwhile, a product may be included within the occasional recommendation list 120 based on how recently the product was used by the customer in question. For example, a product used 25 times in the past 2 years might be a good candidate for the frequent recommendation list 118, while a different product, used only 5 times, but all within the past 2 weeks, might be a good candidate for the occasional recommendation list 120. Various specific examples are provided with more detailed calculations for determining the list 118, 120.

As also shown, other categories or classifications may be used with respect to products of the product database 110. For example, a recommendation black list 122 may be constructed that includes products that should not be included within a current recommendation set to be provided to a particular customer. For example, as also described in detail below, a product that has previously been recommended to a particular customer a number of times, but never used by that customer, might be a good candidate for inclusion within the recommendation black list. Nonetheless, it will be appreciated that the recommendation black list 122, like the list 118, 120, may be understood to include products that may be reclassified or re-categorized among the various lists 118, 120, 122 over time, as different sets of recommendation sets are provided serially to a corresponding customer. In other words, for example, if a particular customer is provided with a recommendation set every day, the recommendation list handler 116 may be configured to dynamically adjust and alter the products contained within each of the lists 118, 120, 122, as part of the overall techniques described herein for ensuring that the customer in question continually receives recommendation sets that are appropriately suited to the customer's changing interest over time.

Thus, the recommendation list handler 116 is configured to input a number of products “p” up to a total number “M,” and output, in the example of FIG. 1, the three lists 118, 120, 122, each populated with a determined number of products of the total number of M products. For example, in the simplified example, for a number of products M=100, the recommendation black list 122 might contain 50 of the products, while the occasional recommendation list 120 might contain 30 products, and the frequent recommendation list 118 might contain 20 products. It will be appreciated that these numbers are just examples, and that an absolute number of products in each list, although potentially subject to various predetermined thresholds or calculation constraints, need not be preset to a designated number or percentage in the implementation of FIG. 1. Instead, the number of products in each of the lists 118, 120, 122 may change in conjunction with generation of each of a plurality of successes recommendation sets.

A recommendation ratio prediction engine 124 may be configured to predict a ratio of frequent to occasional recommendations within a recommendation set of predetermined size. For example, for a simplified example in which the recommendation set includes a number L of 10 products per recommendation set, the recommendation ratio prediction engine 124 may determine, for a current recommendation set to be generated, a recommendation ratio of 20% for the frequent to occasional ratio. In the example, therefore, the recommendation set of L=10 would include 2 recommendations selected from the frequent recommendation list 118, and 8 recommendations selected from the occasional recommendation list 120.

As with the list 118, 120, 122, it will be appreciated that the recommendation ratio predicted by the recommendation ratio prediction engine 124 for a recommendation set currently being generated may be different than a recommendation ratio predicted for earlier or subsequent recommendation sets. In other words, as referenced above, the recommendation ratio may be dynamic, and may change over time as new recommendation sets are formulated and provided.

Moreover, it will be appreciated that, in at least some embodiments, the recommendation ratio may be calculated separately or independently from the number of products included in each of the lists 118, 120, 122. For example, in the example just given in which the recommendation ratio=20%, it would be necessary to choose 2 recommendations from the 20 products in the frequent recommendation list 118, while choosing 8 products from among the 30 products included within the occasional recommendation list 120. However, in another example recommendation set, it may occur that the frequent recommendation list 118 includes only 10 products, while the occasional recommendation list 120 includes 40 products, and that the value for the recommendation ratio for that recommendation set may be set partially or completely independently of such fluctuations in the sizes of the list 118, 120, 122.

Thus, the recommendation ratio reflects individualized preferences of the customer for whom a corresponding recommendation ratio is generated. For example, one customer may have a high recommendation ratio including a large proportion of frequently-used products, reflecting the fact that the customer enjoys habitually visiting the same or similar types of products. Meanwhile, a low recommendation ratio for a second user may indicate that the user does not enjoy repeating uses of the same or similar products, and/or does not enjoy using the types of products that customers tend to use repetitively, and instead enjoys, or is more likely to seek out, new or different types of products. Further, even for a single customer, as described herein, the customer's recommendation ratio may be adjusted up or down over time, as new recommendation sets are sequentially generated over time for that customer, thereby reflecting the changing interests of that customer over time, as well.

A frequent recommendation optimizer 126 is configured to select recommendations from the frequent recommendation list 118, in accordance with the recommendation ratio of the recommendation ratio prediction engine 124. Similarly, an occasional recommendation optimizer 128 is configured to select occasional recommendations from the occasional recommendation list 120, and also in accordance with the recommendation ratio. It will be appreciated that, by themselves, a number of known techniques exist for measuring similarities between products or types of products. Accordingly, the optimizers 126, 128 may utilize any such appropriate techniques, including techniques discovered in the future, to determine various similarity measures that might be useful in ultimately generating a recommendation set for display via the recommendation UI 106.

For the sake of illustration and example, specific example techniques for calculating relative levels or types of similarity are provided below. In general, products may be classified according to various criteria, so that if a customer uses a particular product, a similarly-classified product will therefore be considered to be similar. In other scenarios, two or more customers may be classified according to predetermined criteria. Then, a first customer classified similarly to a second customer might be likely to receive a recommendation including a product used by the second customer.

In all such techniques for generating recommendations based on similarity scores, or combinations of such techniques, the frequent recommendation optimizer 126 is configured to select from the frequent recommendation list 118 based on a waiting of such similarity scores that is dictated by a relative frequency of use of each product within the frequent recommendation list 118. In other words, as described herein, such frequency of use may include a total number of times a product has been used within a defined timeframe (e.g., within the past month, the past year, or within an entirety of time tracked by the use history database).

Meanwhile, the occasional recommendation optimizer 128 may also use appropriately-selected techniques for measuring product similarities and selecting from the occasional recommendation list 120. Further, as also described herein, the occasional recommendation optimizer 128 may wait such selection processes based on relative levels of latency of use of each product within the occasional recommendation list 120 by the customer in question. In other words, latency refers to an amount of time that has passed since a particular product has been used, so that a high latency reflects a relatively long duration of time since the customer used the product, while a low latency reflects a relatively recent use of the product.

A recommendation aggregator 130 may be configured to receive outputs of the frequent recommendation optimizer 126 and the occasional recommendation optimizer 128, and construct a recommendation set therefrom, in accordance with the recommendation ratio of the recommendation ratio prediction engine 124. For example, in a simplified example in which the recommendation set has been designated to include 10 recommendations, and the recommendation ratio is set at 0.2 or 20%, then the frequent recommendation optimizer 126 will provide 2 recommendations from the frequent recommendation list 118, while the occasional recommendation optimizer 128 will provide 8 occasional recommendations from the occasional recommendation list 120. The recommendation aggregator 130 will thus aggregate the 2 recommendations from the frequent recommendation optimizer 126 with the 8 recommendations from the occasional recommendation optimizer 128, to thereby provide the resulting recommendation set using the recommendation UI 106.

Finally with respect to FIG. 1, the recommendation optimizer 102 is illustrated as being executed using at least one computing device 132, which itself includes at least one processor 134 and a non-transitory computer readable storage medium 136. For example, the at least one computing device 132 may represent one or more computing devices configured to implement the recommendation optimizer 102 by causing the at least one processor 134 to access corresponding instruction stored using the non-transitory computer readable storage medium 136.

Of course, as is apparent, the at least one computing device 132 is intended as a highly simplified representation of the types of computing devices that may be utilized to provide the production schedule generator 102, and therefore does not explicitly illustrate various known hardware/software components that may be utilized in the various implementations of the system 100. For example, the at least one computing device 132 does not explicitly illustrate, but would include, a monitor or other appropriate display device for providing the recommendation schedule UI 106, network-related hardware/software for enabling network communications between the various components of the recommendation optimizer 102, as needed, and between the various databases of the recommendation repository 104, and various other input/output and other human interface components.

For example, two or more computing devices, or one or more computing devices having two or more processors each, may execute individual components of the recommendation optimizer 102, perhaps in parallel. For example, the various operations of the optimizers 126, 128 may be conducted in a partially or completely overlapping or parallel manner.

Further, although the recommendation optimizer 102 is illustrated as including a number of separate, discrete components, it will be appreciated that any two or more components or sub-components may be combined for operation of the single component, while, conversely, a single component may be operated as two or more separate sub-components.

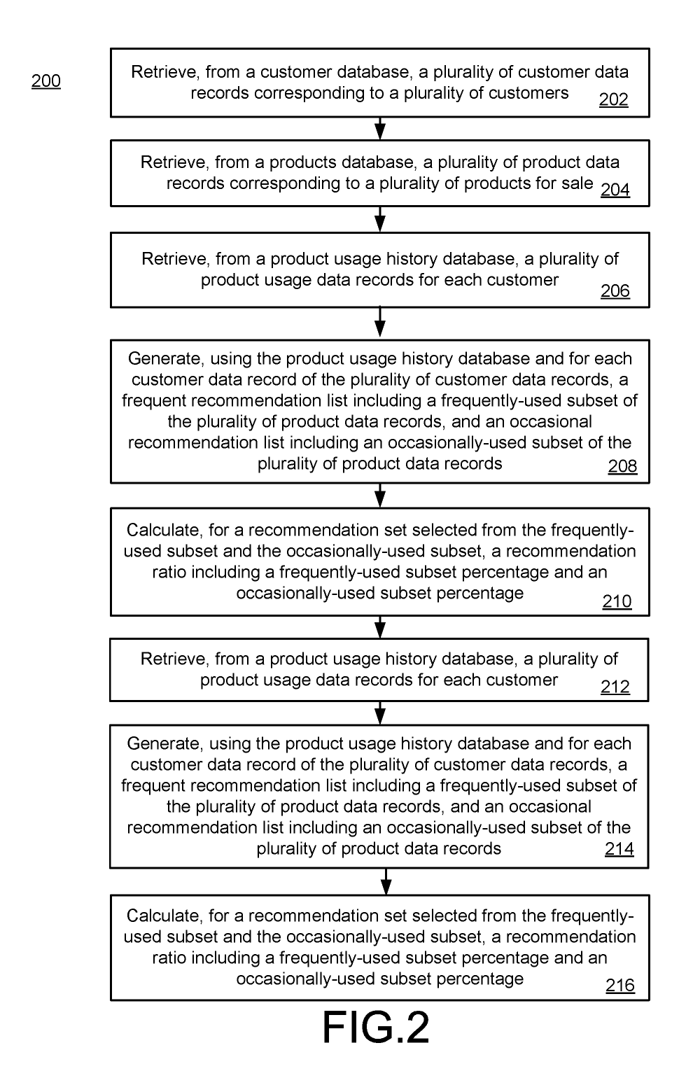

FIG. 2 is a flowchart 200 illustrating example operations of the system 100 of FIG. 1. In the example of FIG. 2, operations 202-216 are illustrated as separate, sequential operations. In various implementations, additional or alternative operations or sub-operations may be included, and/or one or more operations or sub-operations may be omitted. In all such implementations, any two or more operations or sub-operations may be executed in a partially or completely overlapping or parallel manner, or in a nested, iterative, looped, or branched fashion.

In the example of FIG. 2, a plurality of customer data records corresponding to a plurality of customers may be retrieved from a customer database (202). For example, the recommendation optimizer 102 may retrieve the customer data records from the customer database 108.

A plurality of product data records corresponding to a plurality of product data records corresponding to a plurality of products for sale may be retrieved from a product database (204). For example, as described, the recommendation optimizer 102 may retrieve the product data records from the product database 110.

A plurality of product usage data records may be retrieved from a product usage history database (206). For example, as also described above, the recommendation optimizer 102 may retrieve the product usage data records from the use history database 112.

Using the product usage history database and for each customer data record of the plurality of customer data records, a frequent recommendation list including a frequently used subset of the plurality of product data records may be generated, and an occasional recommendation list including an occasionally used subset of the plurality of product data records may be generated (208). For example, the recommendation list handler 116 may generate the frequent recommendation list 118 and the occasional recommendation list 120. In general, as described herein, the frequent recommendation list 118 will be constructed based on a frequency of use of each product. Additionally, as described in detail below, the recommendation list handler 116 may also utilize the recommendation history database 114 to generate the frequent recommendation list 118. For example, the recommendation list handler 116 may consider a number of times that a particular product has been used, relative to a number of times that the customer previously received the recommendation for that product within one or more earlier-provided recommendation sets.

In other words, if the product has been recommended multiple times, and has thereafter been used by the customer, then the product will be more likely to be included within the frequent recommendation list 118. On the other hand, as also referenced above and described in detail below, if the recommendation list handler 116 utilizes the recommendation history database 114 to determine that a product has been recommended previously multiple times, but has never or rarely been used by the customer, then the recommendation list handler 116 may include that product within the recommendation black list 122. In such scenarios, the recommendation list handler 116 may generate the occasional recommendation list 120 simply by all products within the plurality of products that are not already included within the frequent recommendation list 118 and the recommendation black list 122.

For a recommendation set selected from the frequently used subset and the occasionally used subset, a recommendation ratio including a frequently-used subset percentage and occasionally-used subset percentage may be calculated (210). For example, the recommendation ratio prediction engine 124 may be configured to predict a recommendation ratio dictating a number of frequent recommendations from the frequent recommendation list 118 and a number of occasional recommendations from the occasional recommendation list 120 to be included within a recommendation set to be generated.

Frequent recommendations may be selected from the frequent recommendation list, based on similarity to products previously used by the corresponding customer, and including waiting the similarity based on the number of times each product of the plurality of products has been used by the corresponding customer, as determined from the product usage history database (212). For example, the frequent recommendation optimizer 126 may utilize various types of similarity measures, examples of which are provided below, in conjunction with the described waiting of the similarity measures based on the number of times a corresponding product has been used by the customer in question, to thereby obtain a frequently-used subset from the frequent recommendation list.

Occasional recommendations may be selected from the occasional recommendation list, based on similarity to products previously used by the corresponding customer, including waiting the similarity using a latency of use of each product or a plurality of products by the corresponding customer, as determined by the product usage history database (214). For example, the occasional recommendation optimizer 128 may use the same, similar, or different similarity measurements as the frequent recommendation optimizer 126, but with respect to the occasional recommendation list 120, and with a waiting dictated by the latency of use of each product by the corresponding customer for whom the recommendation set is being generated, to thereby obtain a occasionally-used subset from the occasional recommendation list.

The recommendation set, including the frequent recommendations and the occasional recommendations, may then be provided in accordance with the recommendation ratio (216). For example, the recommendation aggregator 130 may construct the recommendation set based on the outputs of the optimizers 126, 128, and for display using the recommendation UI 106.

FIGS. 3A-3D are example database tables illustrating implementations of the databases 108-114 of FIG. 1. Specifically, FIG. 3A illustrates an example database table for the customer database 108 of FIG. 1. As shown, the customer database 108 may include a first column 302 identifying rows for a customer identifier (ID), a name, an age, and a gender of each customer. A second column 304 includes corresponding fields for each row, for each customer. Other identifying or relevant characteristics for each customer also may be included.

Similarly, a table of FIG. 3B illustrates an example of the product database 110. As shown, the table may include a column 306 identifying rows for a product identifier (ID) and a product name. Other product details for each product, or product type, also may be included.

A table of FIG. 3C illustrates an example of the use history database 112. As shown, the table may include a column 310 identifying rows for each use event (e.g., a purchase, or a visit). The rows may include a customer ID of a customer and a corresponding product ID of the product used during the use event. A sequence number row identifies a number of the recommendation set within the overall recommendation set for the identified customer in which the use event occurred. That is, if the system 100 has provided 100 recommendation sets, the sequence number row will identify that the use event happened in conjunction with, e.g., recommendation set 50. Finally, a timestamp row may be used to provide a timestamp identifying the time at which the use event occurred. Then, a column 312 may include corresponding values in each row, for each customer.

In a table FIG. 3D, an example of the recommendation history database 114 is illustrated. As shown, a column 314 is illustrated as including rows for an identifier (ID) of a particular recommendation set, a customer ID of a customer for whom the recommendation set was generated, and a product ID of a product(s) included. The table also may include a sequence number of a particular recommendation set, and a timestamp at which the recommendation set was generated. A column 316 thus includes rows with fields filled with data values corresponding to the rows of column 314. As may be appreciated from the above description of FIG. 1, the table of FIG. 3D thus may represent a current output recommendation set to be provided to the recommendation UI 106, or an example of a previously-generated and stored recommendation set.

As referenced above, and described in detail below, the tables of FIGS. 3C and 3D enable a determination of when a use event happened, relevant to a corresponding recommendation, if any. For example, if the system 100 recommends a particular restaurant within a particular recommendation set generated at a particular time, and the use event occurs at a timestamp shortly thereafter, an inference may be drawn that there was correlation or causation between the recommendation and the use event, e.g., that the recommendation was successful. On the other hand, if a particular product is recommended, perhaps multiple times, and never used, then an inference may be made that the recommendation was not useful or successful. In this latter case, the product in question may be included on the recommendation blacklist 122, as referenced above and described in detail, below.

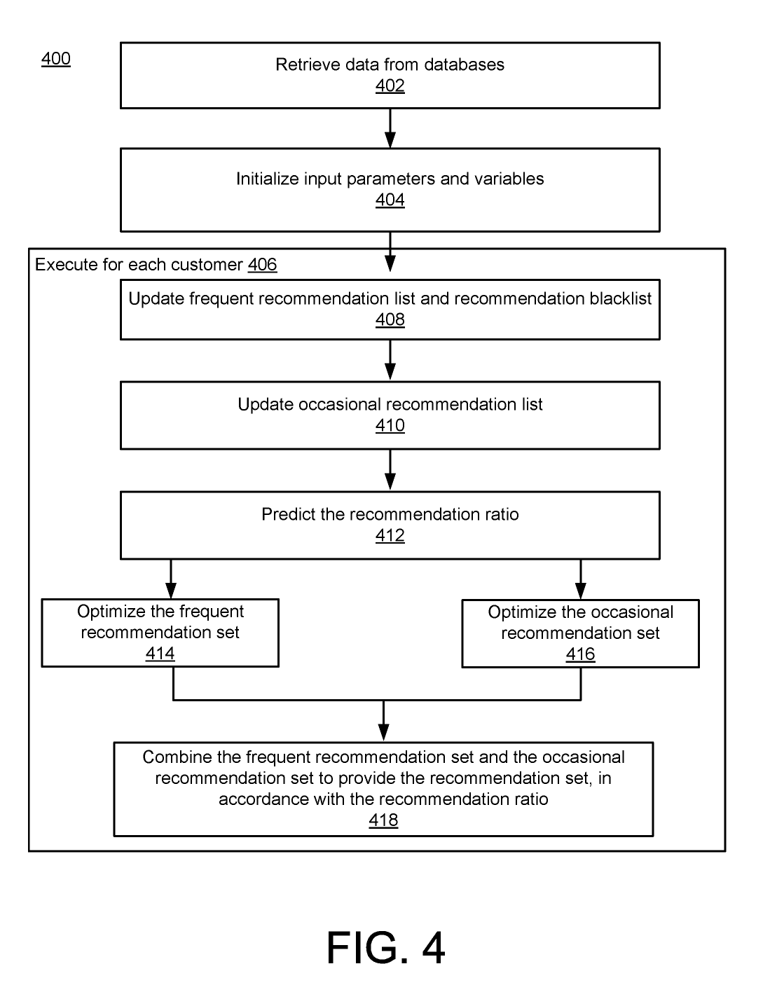

FIG. 4 is a flowchart illustrating more detailed example operations of the system 100 of FIG. 1. The example of FIG. 4 is provided below in conjunction with specific algorithms and techniques, along with example associated pseudocode, for implementing example implementations of the system 100 of FIG. 1. In the examples, it is assumed that the type of use is a visit, such as for recommendations of restaurants, retail stores, and other physical locations. Of course, it will be appreciated from the above that any relevant and appropriate type of product use is contemplated. More generally in the examples, the following notation of Table 1 is used throughout. The notation is summarized in Table 1 as follows for the sake of convenience, and individual notations are explained in detail in the context of the corresponding operation(s) of FIG. 4, where appropriate.

TABLE 1

| Notation | Description |
|---|---|
| Cᵢ | Customer i |
| | i = 1, 2, . . . , N |
| Pⱼ | Product j |
| | j = 1, 2, . . . , M |
| L | Size of recommendation set, i.e., number of recommendations in the |
| | recommendation set |
| T | Current sequence number of recommendation set |
| T + 1 | Next sequence number of recommendation set |
| T − 1 | Previous sequence number of recommendation set |
| Int | Interval between two recommendation sets, e.g., one day |
| TS | Timestamp of next recommendation set |
| k | Sequence number of recommendation set |
| | k = 1, 2, . . . , T |
| Rᵢⱼₖ | ${R}_{ijk} = \{ \begin{matrix}1 & if {P}_{j} is recommended for {C}_{i} at k \\ 0 & otherwise\end{matrix}$ |
| | i = 1, 2, . . . , N |
| | j = 1, 2, . . . , M |
| | k = 1, 2, . . . , T |
| | Provides an indication as to whether a particular product was included within |
| | a particular recommendation set; part of a recommendation history |
| Sᵢⱼₖ | ${S}_{ijk} = \{ \begin{matrix}1 & if {P}_{j} is recommended for {C}_{i} at k and {P}_{j} is not visited by {C}_{i} later , \\ & i . e . , {R}_{ijk} = 1 and {\sum }_{h = k}^{T} {V}_{ijh} = 0 \\ 0 & otherwise\end{matrix}$ |
| | i = 1, 2, . . . , N |
| | j = 1, 2, . . . , M |
| | k = 1, 2, . . . , T |
| | Provides an indication that a product was recommended but not visited, |
| | using Vᵢⱼₖ below |
| Vᵢⱼₖ | Vᵢⱼₖ is the number of visiting Pⱼ by Cᵢ at k |
| | i = 1, 2, . . . , N |
| | j = 1, 2, . . . , M |
| | k = 1, 2, . . . , T |
| Vᵢⱼₖ′ | Vᵢⱼₖ′ is the latest timestamp of visting Pⱼ by Cᵢ at k |
| | i = 1, 2, . . . , N |
| | j = 1, 2, . . . , M |
| | k = 1, 2, . . . , T |
| | Provides an indication of use latency of a particular product, e.g., whether |
| | the customer used the product recently or not; useful as a weight in |
| | recommending products from the occasional recommendation list. |
| Wᵢⱼₖ | ${W}_{ijk} = \{ \begin{matrix}1 & if {P}_{j} is visited by {C}_{i} at k \\ 0 & otherwise\end{matrix}$ |
| | i = 1, 2, . . . , N |
| | j = 1, 2, . . . , M |
| | k = 1, 2, . . . , T |
| | Provides an indication of whether a product is used by a particular customer; |
| | useful in determining a measure of similarity between two different |
| | products, on the presumption that customer tend to use similar products. |
| Uᵢⱼₖ | ${U}_{ijk} = \{ \begin{matrix}{V}_{ijk} & if {P}_{j} is visited by {C}_{i} at k and {P}_{j} is already recommended for C \text{?} \\ & at least once , i . e . , {V}_{ijk} > 0 and {\sum }_{h = 1}^{k} {R}_{ijh} > 0 \\ 0 & otherwise\end{matrix}$ |
| | i = 1, 2, . . . , N |
| | j = 1, 2, . . . , M |
| | k = 1, 2, . . . , T |
| | Provides an indication of a number of times a customer visited a |
| | recommended product |
| X | Minimum ratio of frequent recommendations: provides a threshold |
| | frequency level, e.g., provides a minimum number or percentage of times |
| | that a particular product is included within earlier recommendation sets to |
| | be classified as frequent recommendation list |
| Y | Minimum ratio of visited recommendations: provides a threshold for a |
| | number or percentage of visits required to be considered a successful |
| | recommendation |
| Z | Maximum ratio of unvisited recommendations: provides a threshold for a |
| | number or percentage of times a product can be recommended and not |
| | visited before being blacklisted for purposes of the next recommendation set |
| Fᵢ | Frequent recommendation list for Cᵢ |
| | i = 1, 2, . . . , N |
| Bᵢ | Recommendation blacklist for Cᵢ |
| | i = 1, 2, . . . , N |
| Aᵢ | Percentage of frequent recommendations for Cᵢ within an upcoming |
| | recommendation set |
| | i = 1, 2, . . . , N |
| └LAᵢ┘ | Number of frequent recommendations for Cᵢ at T + 1 |
| | i = 1, 2, . . . , N |
| | Number of frequent recommendations from frequent recommendation list |
| | to be included in next recommendation set; may need to be converted to an |
| | integer value |
| L − └LAᵢ┘ | Number of occasional recommendations for Cᵢ at T + 1 |
| | i = 1, 2, . . . , N |
| D_{id} | Frequent recommendation P_{d} in Fᵢ: an element within the frequent |
| | recommendation list data structure Fᵢ |
| | d ∈ [1, M] |
| Eᵢₑ | Frequent recommendation Pₑ in Fᵢ where V_{ieT} > 0: provides the element D_{id} |
| | with an additional condition of number of visits |
| | e ∈ [1, M] |
| H_{de} | Similarity between P_{d} and Pₑ at T, less means more similar |
| | ${H}_{de} = {\sum }_{i = 1}^{N} \vert {W}_{idT} - {W}_{ieT} \vert$ |
| | d ∈ [1, M] |
| | e ∈ [1, M] |
| Gᵢₑ | Similar products set for Eᵢₑ at T (temporary variable) |
| Iᵢ | Union of all Gᵢₑ at T, frequent recommendation candidate set |
| | Iᵢ = ∪ Gᵢₑ |
| J_{if} | Frequent recommendation candiate in Iᵢ |
| | f ∈ [1, M] |
| K_{fe} | Similarity between P_{f} and Pₑ at T, less means more similar |
| | ${K}_{fe} = {\sum }_{i = 1}^{N} \vert {W}_{ifT} - {W}_{ieT} \vert$ |
| | f ∈ [1, M] |
| | e ∈ [1, M] |
| O_{if} | Weighted similarity sum between P_{f} and all Pₑ for Cᵢ at T, less means more |
| | similar to all visited frequent recommendations by Cᵢ at T |
| | ${O}_{if} = {\sum }_{e} {K}_{fe} {V}_{ieT}$ |
| | f ∈ [1, M] |
| | e ∈ [1, M] |
| Qᵢ | Frequent recommendation set for Cᵢ at T + 1 |
| Fᵢ′ | Occasional recommendation list for Cᵢ |
| | Fᵢ′ = {Pⱼ} − Fᵢ − Bᵢ |
| | i = 1, 2, . . . , N |
| | j = 1, 2, . . . , M |
| | From a notational perspective, and as may be observed from the present |
| | variable and from Table 1 in general, variables including a prime (i,e., ′) |
| | indicator represent variables for the occasional recommendation list that |
| | correspond to the same variables or types of variables as defined and |
| | described above for the frequent recommendation list. That is, for example, |
| | Fᵢ is the frequent recommendation list, while Fᵢ′ represents the occasional |
| | recommendation list, and so on. |
| D_{ig}′ | Occasional recommendation P_{g} in Fᵢ′ |
| | g ∈ [1, M] |
| Eᵢₗ′ | Occasional recommendation Pₗ in Fᵢ′ where V_{ilT} > 0 |
| | l ∈ [1, M] |
| H_{gl}′ | Similarity between P_{g} and Pₗ at T, less means more similar |
| | ${H}_{gl}^{′} = {\sum }_{i = 1}^{N} \vert {W}_{igT} - {W}_{ilT} \vert$ |
| | g ∈ [1, M] |
| | l ∈ [1, M] |
| Gᵢₗ′ | Similar product set for Eᵢₗ′ at T |
| Iᵢ′ | Union of all Gᵢₗ′ at T, occasional recommendation candidate set |
| | Iᵢ′ = ∪ Gᵢₗ′ |
| Jᵢₘ′ | Occasional recommendation candidate in Iᵢ′ |
| | m ∈ [1, M] |
| Kₘₗ′ | Similarity between Pₘ and Pₗ at T, less means more similar |
| | ${K}_{ml}^{′} = {\sum }_{i = 1}^{N} \vert {W}_{imT} - {W}_{ilT} \vert$ |
| | m ∈ [1, M] |
| | l ∈ [1, M] |
| Oᵢₘ′ | Weighted similarity sum between Pₘ and all Pₗ for Cᵢ at T, less means more |
| | similar to all visited occasional recommendations by Cᵢ at T |
| | ${O}_{im}^{′} = {\sum }_{l} \frac{{K}_{ml}^{′} Int}{TS - {V}_{ilT}^{′}}$ |
| | m ∈ [1, M] |
| | l ∈ [1, M] |
| Qᵢ′ | Occasional recommendation set for Cᵢ at T + 1 |

$\text{?} \text{indicates text missing or illegible when filed}$

As shown in Table 1, the following algorithms assume the presence and inclusion of N customers Cᵢ,i=1, 2, . . . , N, and M products Pⱼ,j=1, 2, . . . , M. The recommendation system 100 of FIG. 1 recommends various L products to each customer periodically, with interval Int based on the various recommendation history Rᵢⱼₖ (Pⱼ is recommended to Cᵢ at k) and visiting history Vᵢⱼₖ (how many times Cᵢ visited Pⱼ at k).

The current sequence number of recommendation set is T, which means that the recommendation system has already recommended products to each customer T times. In the example of FIG. 4, it is thus assumed that the recommendation system generates recommendations sets for various products to corresponding, various customers for T+1.

In the example of FIG. 4, when it is time to generate a new recommendation set, data is retrieved from the appropriate databases 108-114 (402). Input parameters and variables may then be initialized (404).

For example, the input parameters X (Minimum ratio of frequent recommendations), Y (Minimum ratio of visited recommendations), and Z (Maximum ratio of unvisited recommendations) from Table 1 may be initialized. Further, the variables T (Current sequence number of recommendation set), T+1 (next sequence number of recommendation set), T−1 (previous sequence number of recommendation set), and TS (timestamp of next recommendation set) may be initialized.

Then, for each customer (406), the frequent recommendation list and the recommendation blacklist may be updated (408), and the results may then be used to update the occasional recommendation list (410). That is, as described, the various recommendation lists are not static or fixed between recommendation sets; they are dynamic for each new recommendation set. For example, if a product was in the frequent recommendation list for a preceding recommendation set, but an interest(s) of the customer changes, the system may not recommend the product anymore. Consequently, the system may be configured to update each recommendation list before each recommendation set is generated. More detailed techniques for generating the recommendation lists (408, 410) are provided below.

Then, a recommendation ratio indicating a percentage of frequent/occasional recommendations for a recommendation set of a certain size may be predicted (412). That is, as described, the recommendation ratio is also neither static nor fixed, and is dynamic for each new recommendation set. Accordingly, the customer is provided with appropriate opportunities either to try a new product, or revisit a known favorite product.

The frequent recommendation set may then be optimized (414), perhaps in parallel with the optimization of the occasional recommendation set (416). That is, once the recommendation ratio is predicted, a number of frequent recommendations to be included will be known, representing perceived major interests of the customer. As referenced above, and described in detail below, the frequent recommendation set is optimized using a weighted similarly measure based on a number of times (frequency) the product was visited.

Meanwhile, also from the knowledge of the recommendation ratio, a number of occasional recommendations to be included will be known, representing recent or temporary interests of the customer. As referenced above, and described in more detail below, the occasional recommendation set is optimized using a weighted similarity measure based on a use latency representing an amount of time that has passed since a most-recent visit(s). As also referenced, the optimization operations (414, 416) may be executed in parallel, so as to provide the recommendation set as quickly and efficiently as possible.

Finally in FIG. 4, the frequent and occasional recommendations are combined to provide the final recommendation set (418). As described, the current recommendation set may be provided for display on the recommendation UI 106. Further, the recommendation set may be stored within the recommendation history database 114 for use in future calculations.

In more detailed examples, for the updating of the frequent recommendation list and the recommendation blacklist (408), the following procedures may be used. In particular, for each product Pⱼ, the following operations may be executed. First, the following variables may be emptied for initialization: Fᵢ: Frequent recommendation list for Cᵢ, and Bᵢ: Recommendation blacklist for Cᵢ. Then, results for the following equations may be calculated:

$$\frac{{\sum }_{k = 1}^{T} {R}_{ijk}}{T} and \frac{{\sum }_{k = 1}^{T} {S}_{ijk}}{T} .$$

### If

$$\frac{{\sum }_{k = 1}^{T} {R}_{ijk}}{T} \geq X ,$$

then results for the following may be calculated:

$${\sum }_{k = 1}^{T} \frac{{U}_{ijk}}{{R}_{ijk}} .$$

### Then, if

$${\sum }_{k = 1}^{T} \frac{{U}_{ijk}}{{R}_{ijk}} \geq Y and \frac{{\sum }_{k = 1}^{T} {S}_{ijk}}{T} \leq Z ,$$

the product Pⱼ will be put into the frequent recommendation list Fᵢ. However, if

$$\frac{{\sum }_{k = 1}^{T} {S}_{ijk}}{T} > Z ,$$

the product Pⱼ will be put into the recommendation blacklist Bᵢ. At this point, it is straightforward to calculate the occasional recommendation list F′ᵢ={Pⱼ}−Fᵢ−Bᵢ.

To predict the percentage of frequent recommendations Aᵢ, the following variables may be calculated. First, Σⱼ₌₁^{M}(V_{ijT}|Pⱼ in Fᵢ), representing a number of visiting frequent recommended products by Cᵢ at T. Σⱼ₌₁^{M}V_{ijT} represents a number of all visits by Cᵢ at T. Σⱼ₌₁^{M}(V_{ij(T-1)}|Pⱼ in Fᵢ): Number of visiting frequent recommended products by Cᵢ at T−1, and Σⱼ₌₁^{M}V_{ij(T-1)}, representing a number of all visits by Cᵢ at T−1. In this way, the recommendation ratio, e.g., the percentage of frequent recommendations Aᵢ may be updated with the following formula:

$$\frac{{\sum }_{j = 1}^{M} ( {V}_{ij ( T - 1 )} \vert {P}_{j} in {F}_{i} )}{{\sum }_{j = 1}^{M} {V}_{ij ( T - 1 )}} - \frac{{\sum }_{j = 1}^{M} ( {V}_{ijT} \vert {P}_{j} in {F}_{i} )}{{\sum }_{j = 1}^{M} {V}_{ijT}} = \frac{{\sum }_{j = 1}^{M} ( {V}_{ijT} \vert {P}_{j} in {F}_{i} )}{{\sum }_{j = 1}^{M} {V}_{ijT}} - {A}_{i} ,$$

where, if If Aᵢ<0,Aᵢ=0, and If Aᵢ>1,Aᵢ=1.

To optimize the frequent recommendation set (414), i.e., optimize └LAᵢ┘ frequent recommendations for Cᵢ at T+1, the following calculations may be used. For each Eᵢₑ, the following three calculations may be used. First, for each D_{id}, calculate the similarity H_{de}=Σᵢ₌₁^{N}|W_{idT}−W_{ieT}|. Second, sort H_{de} in ascending order and select the first └LAᵢ┘ products D_{id} as Gᵢₑ. Third, calculate Iᵢ, Iᵢ=∪Gᵢₑ as the union of each candidate list. Further, for each J_{if}, the following three calculations may be used. First, for each Eᵢₑ, calculate K_{fe}=Σᵢ₌₁^{N}|W_{ifT}−W_{ieT}|. Second, calculate the weighted similarity O_{if}=ΣₑK_{fe}V_{ieT}, in which, as described herein, the similarity measure is weighted based on the number of visits. Third, sort O_{if} in ascending order and select the first └LAᵢ┘ products J_{if} as the frequent recommendation set Qᵢ.

Analogously for optimizing the L−└LAᵢ┘ occasional recommendations for Cᵢ at T+1, the following three calculations may be performed. Specifically, for each E′ᵢⱼ, first, for each D′_{ig}, calculate the similarity H′_{gl}=Σᵢ₌₁^{N}|W_{igT}−W_{ilT}|. Second, sort H′_{gl} in the ascending order and select the first L−└LAᵢ┘ products D′_{ig} as G′ᵢₗ. Third, calculate I′ᵢ, I′ᵢ=u G′ᵢₗ. Then, for each J′ᵢₘ, the following three operations may be performed. First, for each E′ᵢₗ, calculate K′ₘₗ=Σᵢ₌₁^{N}|W_{imT}−W_{ilT}|. Second,

$${O}_{im}^{′} = {\sum }_{l}^{ } \frac{{K}_{ml}^{′} Int}{TS - {V}_{ilT}^{′}}$$

may be calculated as the weighted similarity, based on use latency (e.g., most recent timestamp), as described herein. Third, O′ᵢₘ may be sorted in ascending order, and the first L−└LAᵢ┘ products J′ᵢₘ may be selected as the occasional recommendation set Q′ᵢ.

Finally with respect to FIG. 4, the frequent recommendation set Qᵢ and the occasional recommendation set Q′ᵢ may be combined (418). Then, the union of Qᵢ∪Q′ᵢ may be provided to the recommendation UI (and stored in the recommendation history database 114) as the next recommendation set at T+1.

The following example pseudocode provides an example implementation that may be used in providing the system of FIG. 1. In Pseudocode 1, the notation of Table 1 is used.

Pseudocode 1

| | |
|---|---|
| 1 | Function optimizeRecommendation(Customers, Products, |
| | Recommendations, Visitings, X, Y, Z): |
| 2 | % Input: Customers - Customers table |

| | |
|---|---|
| 3 | Products - Products table |
| 4 | Recommendations - Recommendation history table |
| 5 | Visitings - Visiting history table |
| 6 | X - Minimum ratio of frequent recommendations |
| 7 | Y - Minimum ratio of visited recommendations |
| 8 | Z - Maximum ratio of unvisited recommendations |

| | |
|---|---|
| 9 | % Output: NextRecSet - Next recommendation set |
| 10 | Initialize input parameters including X, Y, Z |
| 11 | Initialize variables including T, T + 1, T − 1, TS |
| 12 | For each i in customers |

| | |
|---|---|
| 13 | % Phase 1 |
| 14 | For each j in products |

| | |
|---|---|
| 15 | F[i] = { }; |
| 16 | B[i] = { }; |
| 17 | For each k in T |

| | |
|---|---|
| 18 | R += R[i][j][k]; |
| 19 | _S += S[i][j][k]; |
| 20 | If _R >= X |

| | |
|---|---|
| 21 | _UR += UR[i][j][k]; |
| 22 | If _UR >= Y && _S <= Z |

| | |
|---|---|
| 23 | F[i].push(j); |

| | |
|---|---|
| 24 | End if |

| | |
|---|---|
| 25 | End if |
| 26 | If _S > Z |

| | |
|---|---|
| 27 | B[i].push(j); |

| | |
|---|---|
| 28 | End if |

| | |
|---|---|
| 29 | End for |

| | |
|---|---|
| 30 | End for |
| 31 | F’ [i] = products − F[i] − B[i]; |
| 32 | % Phase 2 |
| 33 | For each j in products |

| | |
|---|---|
| 34 | V1 += V[i][j][T − 1]; |
| 35 | V2 += V[i][j][T]; |
| 36 | If F[i].contains(j) |

| | |
|---|---|
| 37 | V3 += V[i][j][T − 1]; |
| 38 | V4 += V[i][j][T]; |

| | |
|---|---|
| 39 | End if |

| | |
|---|---|
| 40 | End for |
| 41 | A[i] = 2(V4 / V2) − V3 / V1; |
| 42 | If A[i] < 0 |

| | |
|---|---|
| 43 | A[i] = 0; |

| | |
|---|---|
| 44 | End if |
| 45 | If A[i] > 1 |

| | |
|---|---|
| 46 | A[i] = 1; |

| | |
|---|---|
| 47 | End if |
| 48 | %Phase 3 |
| 49 | For each e in F[i] && V[i][e][T] > 0 |

| | |
|---|---|
| 50 | For each d in F[i] |

| | |
|---|---|
| 51 | For each i in customers |

| | |
|---|---|
| 52 | H[d][e] += abs(W[i][d][T] − W[i][e][T]); |

| | |
|---|---|
| 53 | End for |
| 54 | Sort H[d][e] in ascending order; |
| 55 | G[i][e] = select top floor (LA[i]) D[i][d]; |

| | |
|---|---|
| 56 | End for |
| 57 | For e in G[i] |

| | |
|---|---|
| 58 | I[i] += G[i][e]; |

| | |
|---|---|
| 59 | End for |

| | |
|---|---|
| 60 | End for |
| 61 | For each f in I[i] |

| | |
|---|---|
| 62 | For each e in E[i] |

| | |
|---|---|
| 63 | For each i in customers |

| | |
|---|---|
| 64 | K[f][e] += abs(W[i][f][T] − W[i][e][T]); |

| | |
|---|---|
| 65 | End for |

| | |
|---|---|
| 66 | O[i][f] += K[f][e] * V[i][e][T]; |

| | |
|---|---|
| 67 | End for |

| | |
|---|---|
| 68 | End for |
| 69 | Sort O[i][f] in ascending order; |
| 70 | Q[i] = select top floor(LA[i]) J[i][f]; |
| 71 | %Phase 4 |
| 72 | For each l in F’ [i] && V[i][l][T] > 0 |

| | |
|---|---|
| 73 | For each g in F’ [i] |

| | |
|---|---|
| 74 | For each i in customers |

| | |
|---|---|
| 75 | H’ [g][l] += abs(W[i][g][T] − W [i][l][T]); |

| | |
|---|---|
| 76 | End for |
| 77 | Sort H’ [g][l] in ascending order; |
| 78 | G’ [i][l] = select top floor(LA[i]) D’ [i][g]; |

| | |
|---|---|
| 79 | End for |
| 80 | For l in G’ [i] |

| | |
|---|---|
| 81 | I[i] += G’ [i][l]; |

| | |
|---|---|
| 82 | End for |

| | |
|---|---|
| 83 | End for |
| 84 | For each m in I’ [i] |

| | |
|---|---|
| 85 | For each l in E’ [i] |

| | |
|---|---|
| 86 | For each i in customers |

| | |
|---|---|
| 87 | K’ [m][l] += abs(W[i][m][T] − W[i][l][T]); |

| | |
|---|---|
| 88 | End for |

| | |
|---|---|
| 89 | O’ [i][m] += (K’ [m][l] * Int) / (TS − V’ [i][l][T]); |
| 90 | End for |

| | |
|---|---|
| 91 | End for |
| 92 | Sort O’ [i][m] in ascending order; |
| 93 | Q’ [i] = select top floor(LA[i]) J’ [i][m]; |
| 94 | RS[i] = Q[i] + Q’ [i]; |

| | |
|---|---|
| 95 | End for |
| 96 | Return RS; |

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to:
retrieve, from a customer database, a plurality of customer data records corresponding to a plurality of customers;
retrieve, from a products database, a plurality of product data records corresponding to a plurality of products for sale;
retrieve, from a product usage history database, a plurality of product usage data records for each customer;
generate, using the product usage history database and for each customer data record of the plurality of customer data records, a frequent recommendation list including a frequently-used subset of the plurality of product data records, and an occasional recommendation list including an occasionally-used subset of the plurality of product data records;
calculate, for a recommendation set selected from the frequently-used subset and the occasionally-used subset, a recommendation ratio including a frequently-used subset percentage and an occasionally-used subset percentage;
select frequent recommendations from the frequent recommendation list, based on similarity to products previously used by the corresponding customer, including weighting the similarity based on the number of times each product of the plurality of products has been used by the corresponding customer, as determined from the product usage history database;
select occasional recommendations from the occasional recommendation list, based on similarity to products previously used by the corresponding customer, including weighting the similarity using a latency of use of each product of the plurality of products by the corresponding customer, as determined from the product usage history database; and
provide the recommendation set including the frequent recommendations and the occasional recommendations, included in accordance with the recommendation ratio.

2. The computer program product of claim 1, wherein the instructions, when executed, are further configured to generate the frequent recommendation list and the occasional recommendation list including:
generate a recommendation blacklist including a blacklisted subset of the product data records identifying products that are prohibited from inclusion within the recommendation set.

3. The computer program product of claim 2, wherein the instructions, when executed, are further configured to generate the frequent recommendation list and the occasional recommendation list including:
analyze each usage history of each product by each customer, relative to at least one threshold, to classify each product for inclusion in either the frequently-used subset or the blacklisted subset; and
generate the occasionally-used subset as including a difference between the plurality of products and the combination of the frequently-used subset and the blacklisted subset.

4. The computer program product of claim 1, wherein the instructions, when executed, are further configured to:
provide the recommendation set as one of a plurality of recommendation sets provided at defined intervals, including updating the frequently-used subset, the occasionally-used subset for each recommendation set of the plurality of recommendation sets.

5. The computer program product of claim 1, wherein the instructions, when executed, are further configured to:
provide the recommendation set as one of a plurality of recommendation sets provided at defined intervals, including updating the recommendation ratio for each recommendation set of the plurality of recommendation sets.

6. The computer program product of claim 1, wherein the instructions, when executed, are further configured to generate the frequent recommendations and the occasional recommendations including:
generating the frequent recommendations and the occasional recommendations in parallel.

7. The computer program product of claim 1, wherein the instructions, when executed, are further configured to generate the frequent recommendation list and the occasional recommendation list including:
access a recommendation history database to determine a number of times a product was recommended; and
generate the frequent recommendation list based at least in part on the number of times a product was recommended, as compared to a number of times the recommended product was used, as determined from the usage history database.

8. The computer program product of claim 1, wherein the instructions, when executed, are further configured to generate the frequent recommendation list and the occasional recommendation list including:
access a recommendation history database to determine a number of times a product was recommended;
determine whether to include the recommended product within the frequent recommendation list based at least in part on the number of times a product was recommended, as compared to a number of times the recommended product was used, as determined from the usage history database; and
determine whether to include the recommended product within a recommendation blacklist including products prohibited from inclusion within the recommendation set, based at least in part on the number of times a product was recommended, as compared to a number of times the recommended product was not subsequently used, as determined from the usage history database.

9. A method comprising:
retrieving, from a customer database, a plurality of customer data records corresponding to a plurality of customers;
retrieving, from a products database, a plurality of product data records corresponding to a plurality of products for sale;
retrieving, from a product usage history database, a plurality of product usage data records for each customer;
generating, using the product usage history database and for each customer data record of the plurality of customer data records, a frequent recommendation list including a frequently-used subset of the plurality of product data records, and an occasional recommendation list including an occasionally-used subset of the plurality of product data records;
calculating, for a recommendation set selected from the frequently-used subset and the occasionally-used subset, a recommendation ratio including a frequently-used subset percentage and an occasionally-used subset percentage;
selecting frequent recommendations from the frequent recommendation list, based on similarity to products previously used by the corresponding customer, including weighting the similarity based on the number of times each product of the plurality of products has been used by the corresponding customer, as determined from the product usage history database;
selecting occasional recommendations from the occasional recommendation list, based on similarity to products previously used by the corresponding customer, including weighting the similarity using a latency of use of each product of the plurality of products by the corresponding customer, as determined from the product usage history database; and
providing the recommendation set including the frequent recommendations and the occasional recommendations, included in accordance with the recommendation ratio.

10. The method of claim 9, wherein generating the frequent recommendation list and the occasional recommendation list includes:
generating a recommendation blacklist including a blacklisted subset of the product data records identifying products that are prohibited from inclusion within the recommendation set.

11. The method of claim 10, wherein generating the frequent recommendation list and the occasional recommendation list includes:
analyzing each usage history of each product by each customer, relative to at least one threshold, to classify each product for inclusion in either the frequently-used subset or the blacklisted subset; and
generating the occasionally-used subset as including a difference between the plurality of products and the combination of the frequently-used subset and the blacklisted subset.

12. The method of claim 9, further comprising:
providing the recommendation set as one of a plurality of recommendation sets provided at defined intervals, including updating the frequently-used subset, the occasionally-used subset for each recommendation set of the plurality of recommendation sets.

13. The method of claim 9, further comprising:
providing the recommendation set as one of a plurality of recommendation sets provided at defined intervals, including updating the recommendation ratio for each recommendation set of the plurality of recommendation sets.

14. The method of claim 9, wherein generating the frequent recommendations and the occasional recommendations includes:
generating the frequent recommendations and the occasional recommendations in parallel.

15. The method of claim 9, wherein generating the frequent recommendation list and the occasional recommendation list includes:
accessing a recommendation history database to determine a number of times a product was recommended; and
generating the frequent recommendation list based at least in part on the number of times a product was recommended, as compared to a number of times the recommended product was used, as determined from the usage history database.

16. The method of claim 9, wherein generating the frequent recommendation list and the occasional recommendation list includes:
accessing a recommendation history database to determine a number of times a product was recommended;
determining whether to include the recommended product within the frequent recommendation list based at least in part on the number of times a product was recommended, as compared to a number of times the recommended product was used, as determined from the usage history database; and
determining whether to include the recommended product within a recommendation blacklist including products prohibited from inclusion within the recommendation set, based at least in part on the number of times a product was recommended, as compared to a number of times the recommended product was not subsequently used, as determined from the usage history database.

17. A system comprising:
at least one processor; and
at least one memory storing instructions are executable by the at least one processor, the system including
a recommendation optimizer configured to cause the at least one processor to generate, for each customer of a plurality of customers, a sequence of recommendation sets recommending products, wherein each recommendation set of the sequence includes frequent recommendations and occasional recommendations, included in proportion to one another in accordance with a recommendation ratio that is dynamically adjusted for each recommendation set in the sequence, the recommendation optimizer further including
a recommendation list handler configured to calculate, for a current recommendation set being generated, a frequent recommendation list including a frequently-used subset of the plurality of products and an occasional recommendation list including an occasionally-used subset of the plurality of products for the customer,
a recommendation ratio prediction engine configured to predict the recommendation ratio for the current recommendation set;
a frequent recommendation optimizer configured to select the frequent recommendations from the frequent recommendation list, based on similarity to products previously used by the corresponding customer, including weighting the similarity based on the number of times each product of the plurality of products has been used by the corresponding customer;
an occasional recommendation optimizer configured to select the occasional recommendations from the occasional recommendation list, based on similarity to products previously used by the corresponding customer, including weighting the similarity using a latency of use of each product of the plurality of products by the corresponding customer; and
a recommendation aggregator configured to provide the recommendation set including the frequent recommendations and the occasional recommendations, included in accordance with the recommendation ratio.

18. The system of claim 17, wherein the recommendation list handler is configured to generate a recommendation blacklist including a blacklisted subset of the products, identifying products that are prohibited from inclusion within the recommendation set.

19. The system of claim 18, wherein the recommendation list handler is configured to dynamically and individually classify each of the plurality of products for inclusion within one of the frequent recommendation list, the occasional recommendation list, and the recommendation blacklist, for each recommendation set of the sequence.

20. The system of claim 17, wherein recommendation list handler is further configured to generate the frequent recommendation list including:
accessing a recommendation history database to determine a number of times a product was recommended; and
generating the frequent recommendation list based at least in part on the number of times a product was recommended, as compared to a number of times the recommended product was used, as determined from a usage history database.
